(19) United States
(12) Patent Application Publication
(10) Pub. No.: US 2005/0071975 A1
(43) Pub. Date: Apr. 7, 2005

(54) Method of forming vehicle body side structure assembly

(76) Inventors: Chi-Mou Ni, Washington, MI (US); Charles J. Bruggemann, Rochester Hills, MI (US); Joseph M. Lendway IV, Dryden, MI (US); David Allen Gatny, Sterling Heights, MI (US); Carl W. Robinson, Almont, MI (US); Michael Gerard Poss, Rochester Hills, MI (US)

Correspondence Address: LAURA C. HARGITT;General Motors Corporation, Legal Staff, Mail Code 482-C23-B21, P.O. Box 300, Detroit, MI, 48265-3000, US

(21) Appl. No.: 10/385,968

(22) Filed: Mar. 11, 2003

(51) Int. Cl. B23P 17/00

(52) U.S. Cl. 29/421.1

(57) ABSTRACT

A method of forming a vehicle body side structure assembly includes the steps of providing a plurality of tubular members to form a frame structure and assembling the tubular members together to pre-form the frame structure. The method also includes the step of positioning the pre-formed frame structure between open die halves mating with one another to define a tubular cavity portion. The method includes the step of closing the die halves to capture the pre-formed frame structure within the tubular cavity portion. The method further includes the step of pressurizing an interior of the pre-formed frame structure to expand and conform the pre-formed frame structure to the tubular cavity portion to form a final frame structure.

### TECHNICAL FIELD

The present invention relates generally to vehicle body side structures and, more particularly, to a method of forming a vehicle body side structure assembly for a vehicle.

### BACKGROUND OF THE INVENTION

It is known to provide a vehicle body side structure assembly for a vehicle. Typically, the vehicle body side structure assembly uses a number of stampings and a spot-welding process to assemble them together into a frame as part of a vehicle body. However, to provide structural rigidity to the vehicle body, a large number of spot-welds are usually required. In addition, assembly variations may occur when a number of stampings are fixtured and welded. Further, additional structural reinforcements are needed to achieve performance. Also, there are relatively large tooling costs required for conventional stampings.

It is also known to hydroform tubular components. Hydroformed tubular components are becoming increasingly popular in automotive body structural applications. During vehicle body manufacturing, methods for hydroforming relatively simple frame structures have been performed. An example of such a method is disclosed in U.S. Pat. No. 5,720,092 to Ni et al. In this patent, a method for producing a frame structure includes the steps of pre-assembling an initial frame having a plurality of cylindrical metal tubes interconnected by the insertion of the ends of the cylindrical tubes onto mating plugs of pre-formed hollow metal nodal joints at substantially uniform circular interfaces. The method also includes the steps of securely joining the tubes and nodal joints by welding at the circular interfaces. The method includes the steps of placing the entire initial frame between a single set of hydroforming dies having mating cavities accommodating the tubes and joints and providing, when closed, a single cavity having a cross-sectional shape matching the cross-sectional shape desired for the completed frame structure. The method further includes the steps of pressurizing the entire interior of the initial frame to expand all of the tubes and joints out into the single cavity concurrently to complete the frame structure.

It is desirable to provide a method of forming a vehicle body side structure assembly for a vehicle that incorporates complex frame structures. It is also desirable to integrate hydroformed parts into a vehicle body side structure assembly. It is further desirable to reduce the number of parts and welding operations of a vehicle body side structure assembly for a vehicle. Therefore, there is a need in the art to provide a method of forming a vehicle body side structure assembly that meets these desires.

### SUMMARY OF THE INVENTION

It is, therefore, one object of the present invention to provide a method of forming a vehicle body side structure assembly for a vehicle.

It is another object of the present invention to provide a method of forming a vehicle body side structure assembly that is integrated and hydroformed to form a complex frame structure.

To achieve the foregoing objects, the present invention is a method of forming a vehicle body side structure assembly for a vehicle including the steps of providing a plurality of tubular members to form a frame structure and assembling the tubular members together to pre-form the frame structure. The method also includes the step of positioning the pre-formed frame structure between open die halves mating with one another to define a tubular cavity portion. The method includes the step of closing the die halves to capture the pre-formed frame structure within the tubular cavity portion. The method further includes the step of pressurizing an interior of the pre-formed frame structure to expand and conform the pre-formed frame structure to the tubular cavity portion to form a final frame structure.

One advantage of the present invention is that a method of forming a vehicle body side structure assembly is provided for a vehicle that forms complex frame structures such as those having a door opening. Another advantage of the present invention is that the method improves mass efficiency and structure performance of a vehicle body side structure or body assembly. Yet another advantage of the present invention is that the method improves body shop assembly efficiency by using a modular sub-assembly body side. Still another advantage of the present invention is that the method saves tooling cost. A further advantage of the present invention is that the method reduces the number of parts and welding operations. Yet a further advantage of the present invention is that the method improves body assembly dimensional accuracy, thereby improving door opening fit-&-finish.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a perspective view of a final vehicle body side structure assembly formed according to a method of the present invention.

FIG. 2 is a perspective view of a pre-formed vehicle body side structure assembly of FIG. 1.

FIG. 3 is an exploded view of a method of forming the vehicle body side structure assembly of FIG. 1 with the pre-formed assembly of FIG. 2 placed between halves of a die set.

### DESCRIPTION OF THE PREFERRED EMBODIMENT

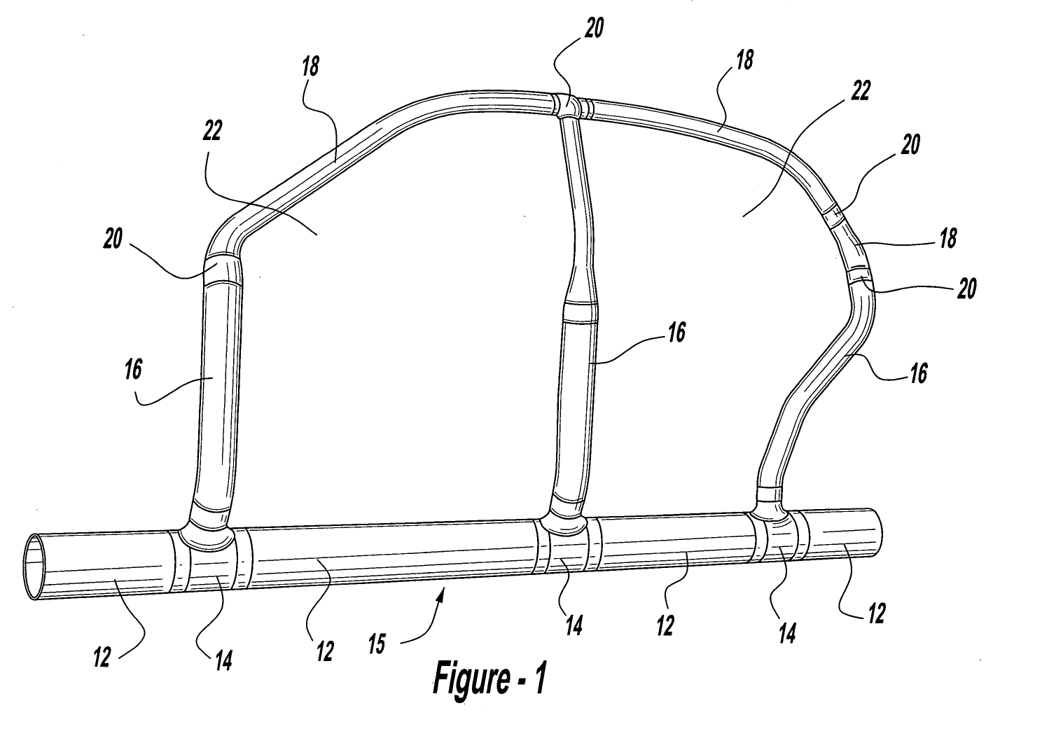

Referring to the drawings and in particular FIG. 1, one embodiment of a vehicle body side structure assembly 10, formed according to a method of the present invention, is shown for a vehicle (not shown). The vehicle body side structure assembly 10 is used as a frame structure for a longitudinal side of the vehicle. It should be appreciated that the vehicle body side structure assembly 10 is a complex frame structure.

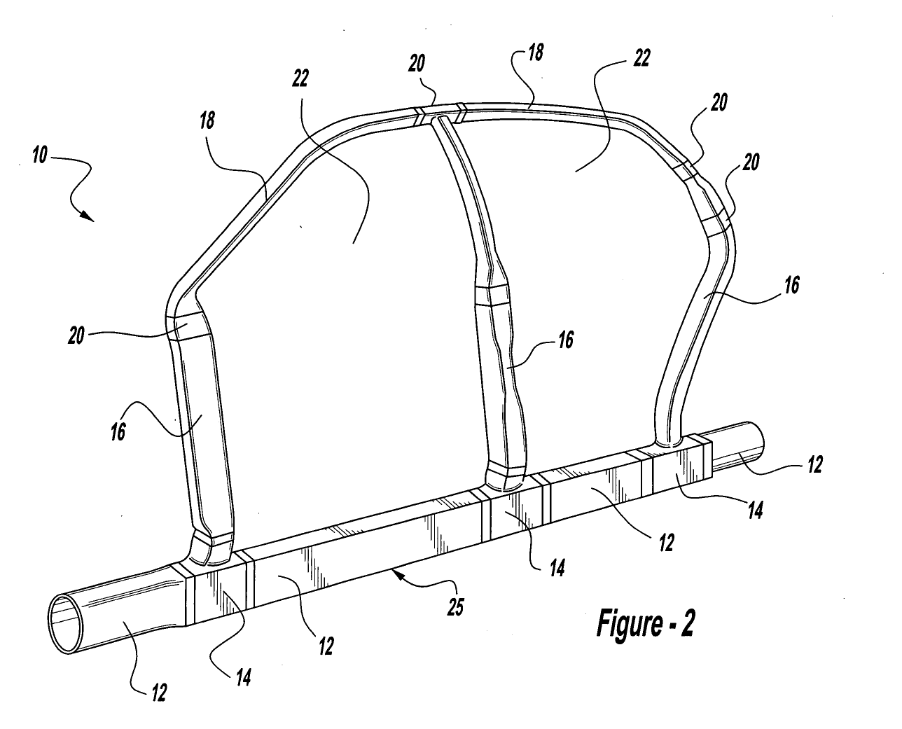

Referring to FIGS. 1 and 2, the method includes the step of providing at least one, preferably a plurality of tubular rocker members 12 to form a rocker at a bottom of the vehicle body side structure assembly 10. The tubular rocker members 12 are made of a metal material. In one embodiment, the tubular rocker members 12 have a generally circular cross-sectional shape and extend axially. The method also includes the step of providing at least one, preferably a plurality of tubular connector members 14 and connecting the tubular rocker members 12 and tubular connector members 14 together to form the rocker. The tubular connector members 14 are made of a metal material. In one embodiment, the tubular connector members 14 have a generally “T” shape with a generally circular cross-sectional shape. It should be appreciated that the members 12 and 14 may have any suitable cross-sectional shape such as rectangular. It should also be appreciated that the importance of the cylindrical shape of both the rocker members 12 and the connector members 14 resides not only in the standardized way in which they can be fitted together, but also in the case with which the two can be welded together, in forming an initial or pre-formed frame structure, generally indicated at 15. Since both are cylindrical, the seams between them are simple circles. Since the connector member 14 is a sleeve that fits over or under the ends of the rocker members 12, those circular seams are farther from the center of the joint than they otherwise would be. It should also be appreciated that the circular seams can be easily accessed and welded by a suitable tool such as a welding tip (not shown) that simply spins around in a circle tracking the raised edge of the seam.

The method includes the step of providing at least one, preferably a plurality of tubular pillar members 16 to form pillars for the vehicle body side structure assembly 10 that extend generally perpendicular to the rocker. The tubular pillar members 16 are made of a metal material. In one embodiment, the tubular pillar members 16 have a generally circular cross-sectional shape and extend axially. In the embodiment illustrated, the tubular pillar members 16 are connected to the tubular connector members 14. The tubular pillar members 16 and connector members 14 are fitted and welded together, as previously described, in forming the preformed frame structure 15.

The method further includes the step of providing at least one, preferably a plurality of tubular roof rail members 18 to form a roof rail for the vehicle body side structure assembly 10 at a top thereof. The tubular roof rail members 18 are made of a metal material. In one embodiment, the tubular roof rail members 18 have a generally circular cross-sectional shape and extend axially. In the embodiment illustrated, the tubular roof rail members 18 are connected either directly to the tubular pillar members 16 or indirectly to the tubular pillar members 16 by tubular connector members 20 to form the roof rail for the vehicle body side structure assembly 10. In one embodiment, the tubular connector members 20 are elbows or T-joints. It should be appreciated that the members 16 and 18 may be bent tubes. It should also be appreciated that the members 16, 18, and 20 may have any suitable cross-sectional shape such as rectangular. It should further be appreciated that the members 12, 14, 16, 18, and 20 may be made of the same metal material such as steel or made of different metal materials from each other.

The method also includes the step of assembling the rocker members 12, connector members 14, pillar members 16, roof rail members 18, and connector members 20 together to pre-form the frame structure 15. The rocker members 12, connector members 14, pillar members 16, roof rail members 18, and connector members 20 are fitted and welded together, as previously described, in forming the pre-formed frame structure 15. It should be appreciated that the rocker members 12, connector members 14,20, pillar members 16, and roof rail members 18 are pre-assembled to form the frame structure having at least one, preferably a pair of door openings 22 that are continuous and closed looped. It should also be appreciated that the door openings 22 are front and rear door openings.

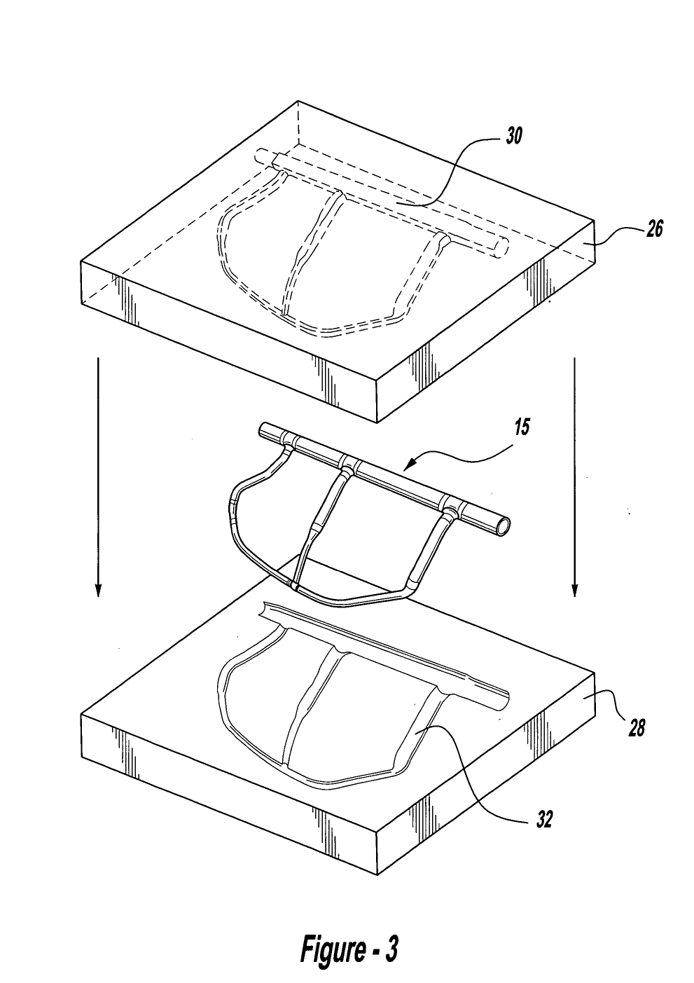

Referring to FIG. 2, once the pre-formed or initial frame structure 15 has been completed, the method also includes the step of hydroforming the frame structure 15 to form a final frame structure, generally indicated at 25, for the vehicle body side structure assembly 10. As illustrated in FIG. 3, the method includes the step of placing or positioning the pre-formed frame structure 15 in a large hydroformed die set comprised of an upper die half 26 and a lower die half 28. The die halves 26 and 28 are similar to standard hydroforming dies, in terms of shape, material of construction, and operation, but are significantly larger, since standard dies form only a single tube. The upper die half 26 includes a tubular forming cavity portion 30 and the lower die half 28 includes a matching tubular forming cavity portion 32, which mate when the die halves 26 and 28 close to form or define a single cavity matching, in shape and size, the outer contour desired for the entire final frame structure 25. The pre-formed frame structure 15 is simply placed between the die halves 26 and 28, aligned with the cavity portions 30 and 32, as a typical, single tube would be. The accuracy with which the various tubes are joined together, at this point, need only be sufficient to locate the pre-formed frame structure 15. It should be appreciated that a combined cross-sectional circumferential measure of the tubular forming cavity portions 30 and 32 total up to generally equal to or slightly greater than the cross-section perimeter length of the final frame structure 25 for the integrated hydroformed vehicle body side structure assembly 10.

The method includes the step of plugging and sealing the open tube ends of the pre-formed frame structure 15 and applying at least nominal internal hydraulic pressure to the pre-formed frame structure 15 by pumping hydraulic fluid into an interior of the pre-formed frame structure 15. The method includes the step of closing the upper die half 26 and lower die half 28 so that the pre-formed frame structure 15 is captured in and between the mating cavity portions 30 and 32. It should be appreciated that the pre-formed frame structure 15 may be deformed or smashed locally to fit into the cavity portions 30 and 32.

The die halves 26 and 28 are fully closed upon one another with the pre-formed frame structure 15 being tightly closed between the die halves 26 and 28. Once the die is closed, the method includes the step of expanding the pre-formed frame structure 15 to a final cross-sectional profile or final frame structure 25 by increasing the hydraulic pressure sufficient to exceed the yield limit of the pre-formed frame structure 15 so that the pre-formed frame structure 15 is forced into conformity with the tubular forming cavity portions 30 and 32 of the die halves 26 and 28. It should be appreciated that, during the hydroforming process, hole piercing may be performed on the pre-formed frame structure 15.

The method includes the step of opening the die halves 26 and 28 and removing the finished or final frame structure 25 for the integrated hydroformed vehicle body side structure assembly 10 from the die halves 26 and 28. The integrated hydroformed vehicle body side structure assembly 10 may be assembled into a vehicle body (not shown). It should be appreciated that the die halves 26 and 28 are designed to provide the desired cross-sectional tubular shape.

Referring to FIG. 1, the final result of internally pressurizing the pre-formed frame structure 15 between the die halves 26 and 28 is a final frame structure 25 in which all members 14,16,18,20 have been pushed out and expanded concurrently, creating a final cross-sectional shape matching that of the surface of the mating die cavity portions 30 and 32. In the embodiment illustrated, that cross-sectional shape is basically rectangular, though it could be any desired shape. The final frame structure 25 is integral and one-piece. Now, the final frame structure 25 has all the flat and flush surfaces necessary for the attachment of body panels (not shown) or the like. In addition, the location in space of all points on the surface of the final frame structure 25 will have been determined by the shape of the heavy, accurately formed die halves 26 and 28, with no need for fixturing or measuring. The effort put once into the machining of the heavy dies is reflected repeatedly in each final frame structure 25, simply from carrying out the basic hydroforming expansion process. The final frame structure 25 can be formed as accurately and repeatably as any single tube could be hydroformed. The degree of stretch and deformation of the surfaces of the constituent tubes as well as the welded seams, is well within the allowable percentage limits feasible for single tubes.

Accordingly, this new single-piece integrated hydroformed vehicle body side structure assembly 10 of hydroformed components provides improved structural performance due to continuously-welded tubes and integral connectors. Various welding processes, such as TIG, MIG, induction, and arc-brazing, can be used for all the identical welding conditions existing at every joint. In addition, since only a single tool is required to hydroform the assembly 10, significant tooling cost savings and better dimensional accuracy can be achieved over the conventional approach. Substantial floor space reduction in the body shop is realized from using this modular vehicle body side structure assembly 10.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. A method of forming a vehicle body side structure assembly, said method comprising the steps of:
providing a plurality of tubular rocker members, connector members, pillar members, and roof rail members;
assembling the tubular rocker members, connector members, pillar members, and roof rail members together to form a frame structure having the rocker members extending axially and the pillar members extending transversely and disposed axially inward from axial ends of the rocker members and the roof rail members extending between the pillar members to form a pair of door openings with each of the door openings having a closed perimeter;
positioning the pre-formed frame structure between open die halves mating with one another to define a tubular cavity portion;
closing the die halves to capture the pre-formed frame structure within the tubular cavity portion;
pressurizing an interior of the pre-formed frame structure to expand and conform the pre-formed frame structure to the tubular cavity portion to form a final frame structure.

2. A method as set forth in claim 1 including the steps of separating the die halves and removing the final frame structure from the die halves.

3. A method as set forth in claim 1 wherein said step of pressurizing comprises pressurizing an interior of the pre-formed frame structure by fluid pressure.

4. A method as set forth in claim 1 wherein said step of assembling includes the step of securing the tubular members together by welding.

5. (CANCELED)

6. (CANCELED)

7. A method as set forth in claim 1 wherein the final frame structure is integral and one-piece.

8. A method as set forth in claim 1 wherein the tubular members are made of one or more metal materials.

9. A method of forming a vehicle body side structure assembly, said method comprising the steps of:
providing a plurality of tubular rocker members, connector members, pillar members, and roof rail members;
assembling the tubular members together to form a frame structure having the rocker members extending axially and the pillar members extending transversely and disposed axially inward from axial ends of the rocker members and the roof rail members extending between the pillar members to form a pair of door openings with each of the door opening having a closed perimeter;
positioning the pre-formed frame structure between open die halves mating with one another to define a tubular cavity portion;
closing the die halves to capture the pre-formed frame structure within the tubular cavity portion;
increasing the hydraulic pressure to expand and conform the pre-formed frame structure to the tubular cavity portion to form a final frame structure;
separating the die halves; and
removing the final frame structure from the die halves.

10. (CANCELED)

11. (CANCELED)

12. A method as set forth in claim 9 wherein said step of assembling includes the step of securing the tubular members together by welding.

13. A method as set forth in claim 9 wherein said step of pressurizing comprises pressurizing an interior of the pre-formed frame structure by fluid pressure.

14. A method as set forth in claim 9 wherein the final frame structure is integral and one-piece.

15. A method as set forth in claim 9 wherein the tubular members are made of one or more metal materials.

16. A method of forming a vehicle body side structure assembly, said method comprising the steps of:
providing a plurality of metal tubular rocker members, connector members, pillar members, and roof rail members to form a frame structure;
pre-assembling, the tubular rocker members, connector members, pillar members, and roof rail members together and securing the members together by welding to form a pre-formed frame structure having the rocker members extending axially and the pillar members extending transversely and disposed axially inward from axial ends of the rocker members and the roof rail members extending between the pillar members to form a pair of door openings with each of the door openings having a closed perimeter;
positioning the pre-formed frame structure between open die halves mating with one another to define a tubular cavity portion;
closing the die halves to capture the preformed frame structure within the tubular cavity portion;
increasing the hydraulic pressure to expand and conform the pre-formed frame structure to the tubular cavity portion to form a final frame structure;
separating the die halves; and
removing the final frame structure from the die halves.
